(19) United States
(12) Patent Application Publication
(10) Pub. No.: US 2026/0246055 A1
(43) Pub. Date: Aug. 20, 2026

(54) BATTERY MODULE ASSEMBLY

(71) Applicant: Rivian IP Holdings, LLC, Irvine, CA (US)

(72) Inventors: Akshay Kishor MURKUTE, Irvine, CA (US); Piyush KHATER, Mission Viejo, CA (US); Bronson ADEN, Huntington Beach, CA (US); Rafael LUJAN, Huntington Beach, CA (US); Sharbel ELKANTATI, Windsor (CA); Vinay Vilas JADHAV, Fremont, CA (US); Tripur Udhav MAHAJAN, Irvine, CA (US)

(21) Appl. No.: 19/057,845

(22) Filed: Feb. 19, 2025

(51) Int. Cl. H01M 50/249; B32B 5/12; B32B 27/32; B60K 1/04; B60L 50/60; B60L 50/64; H01M 50/244; H01M 50/276; H01M 50/278; H01M 50/28; H01M 50/282; H01M 50/514; B60N 2/005; B62D 25/20

(52) U.S. Cl. CPC H01M 50/249; B32B 5/12; B32B 27/32; B60K 1/04; B60L 50/64; B60L 50/66; H01M 50/244; H01M 50/276; H01M 50/278; H01M 50/28; H01M 50/282; H01M 50/514; B32B 2262/101; B32B 2457/10; B60K 2001/0438; B60N 2/005; B62D 25/20; H01M 2220/20

(57) ABSTRACT

A battery module may include features to support and protect components thereof from external stress and from certain electrical conditions. In particular, a battery module can be provided with components that direct forces away from electrical connection regions, such as at terminals of a battery cell, and dampen the impact of applied forces by providing variable compressibility at certain regions, such as footwells of a cabin. A cover can be provided with features that provide structural support, electrical insulation, thermal resilience, and low humidity absorption rate.

### INTRODUCTION

Batteries are often used as a source of power, including as a source of power for electric vehicles that include wheels that are driven by an electric motor that receives power from the batteries. A battery may include several battery cells carried within a module and/or a carrier.

Aspects of the subject technology can help to improve the durability and longevity of batteries of electric vehicles, which can help to mitigate climate change by reducing greenhouse gas emissions.

### SUMMARY

A battery module for an electric vehicle may include features to support and protect components thereof from external stress and from certain electrical conditions. In particular, a battery module can be provided with components that direct forces away from electrical connection regions, such as at terminals of a battery cell, and dampen the impact of applied forces by providing variable compressibility at certain regions, such as footwells of a cabin. A cover can be provided with features that provide structural support, electrical insulation, thermal resilience, and low humidity absorption rate.

According to one or more implementations of the present disclosure, an electric vehicle is described. The electric vehicle can include a cabin defining a first footwell zone and a second footwell zone. The electric vehicle can further include a battery subassembly including a cover for extending across multiple battery cells and a compressible layer abutting the cover. The compressible layer can include a first region and a second region. The first region of the compressible layer can be configured to be aligned with a first footwell zone of a cabin, the first region having a first density. The second region of the compressible layer can be configured to be aligned with a second footwell zone of the cabin, the second region having a second density different from the first density.

The compressible layer can further include a third region that is configured to be aligned with a third footwell zone of the cabin, the third region having the second density. The second density can be higher than the first density. The compressible layer can further include a fourth region that is configured to be aligned with an occupied zone of the cabin, the fourth region having a third density different from the first density and the second density. The third density can be lower than the first density and the second density. The battery subassembly can further include an upper layer on a side of the compressible layer that is opposite the cover.

According to one or more implementations of the present disclosure, a battery subassembly is described. The battery subassembly can include a frame for abutting a peripheral rim of a battery cell and a cover configured to direct forces applied thereto onto the peripheral rim of the battery cell. The cover includes a first layer and a second layer. Each of the first layer and the second layer can include fibers within a polymer matrix, wherein the fibers of the first layer and extend in a first direction and the fibers of the second layer extend in a second direction different from the first direction.

The fibers can include glass fibers. The polymer matrix can include polypropylene, polyethylene terephthalate, another polymer with high surface energy, and/or combinations thereof. The cover can further include a third layer, wherein the second layer is between the first layer and the third layer, wherein fibers of the third layer extend in the first direction. A current collector assembly can be provided between the frame and the cover, wherein the cover is configured to direct forces applied thereto away from an encapsulant between the cover and a central portion of the battery cell and onto the peripheral rim of the battery cell. The cover can form an inner surface defining a concave shape for facing a central portion of the battery cell. The battery subassembly can include a base and potting material between the cover and the base. The battery subassembly can include a layer of foam on a side of the cover that is opposite the frame.

According to one or more implementations of the present disclosure, a method of assembling a battery subassembly is described. The method can include providing battery cells, wherein each of the battery cells defines a central portion including a first terminal and a peripheral rim including a second terminal; providing one or more frames abutting the peripheral rim of each of the battery cells; providing a cover over the one or more frames; and providing a compressible layer over the cover, wherein the compressible layer includes multiple regions having different densities with respect to each other.

Providing the compressible layer includes aligning each of the multiple regions of the compressible layer with respective footwell zones of a cabin. Forming the cover can be performed by joining a first layer and a second layer, wherein each of the first layer and the second layer includes fibers within a polymer matrix, wherein the fibers of the first layer and extend in a first direction and the fibers of the second layer extend in a second direction different from the first direction. The method can further include providing an encapsulant over the central portion of each of the battery cells; connecting a current collector assembly to the first terminal and the second terminal of each of battery cells; providing a base to support the battery cells; and providing potting material between the cover and the base.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a perspective view of an example battery cell in accordance with one or more implementations of the present disclosure.

FIG. 4 illustrates an exploded perspective view of a battery module in accordance with one or more implementations of the present disclosure.

FIG. 5 illustrates a sectional side view of a first portion of a battery module in accordance with one or more implementations of the present disclosure.

FIG. 6 illustrates a sectional side view of a second portion of the battery module of FIG. 5 in accordance with one or more implementations of the present disclosure.

FIG. 7 illustrates a top view of an interior of a vehicle have multiple zones for a compressible layer of a battery module in accordance with one or more implementations of the present disclosure.

FIG. 8 illustrates a perspective view of a cover in accordance with one or more implementations of the present disclosure.

FIG. 9 illustrates a sectional view taken along line A-A of FIG. 8 in accordance with one or more implementations of the present disclosure.

FIG. 10 illustrates a flow diagram showing an example of a process that may be performed for assembling a battery module in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A battery module may be provided with features to support and protect components thereof from external stress and from certain electrical conditions. In particular, a battery module can be provided with components that direct forces away from electrical connection regions, such as at terminals of a battery cell. Such forces can be directed toward other structures that do not define electrical connection regions. In particular, a battery module can be provided with components that direct forces away from electrical connection regions, such as at terminals of a battery cell, and dampen the impact of applied forces by providing variable compressibility at certain regions, such as footwells of a cabin. An assembly for such a battery module can provide guidance to align and secure assembled components and to retain them with a potting material during assembly. A cover can be provided with features that provide structural support, electrical insulation, thermal resilience, and low humidity absorption rate.

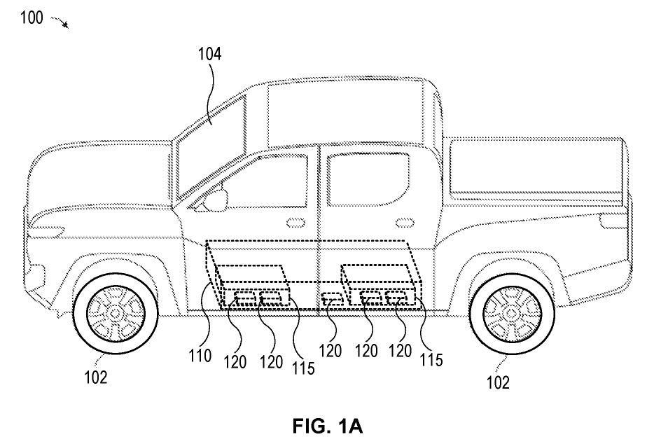

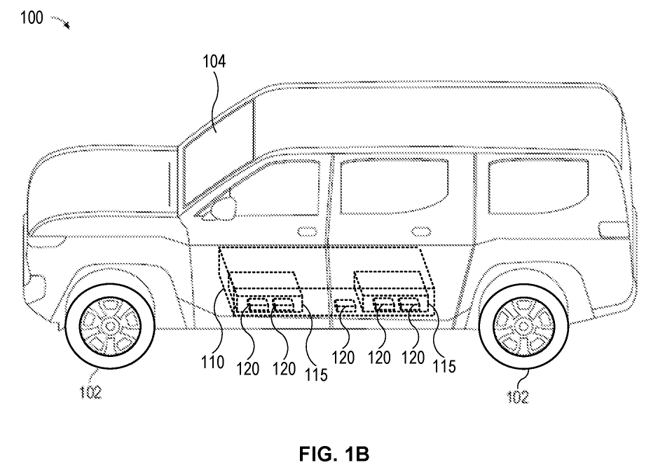

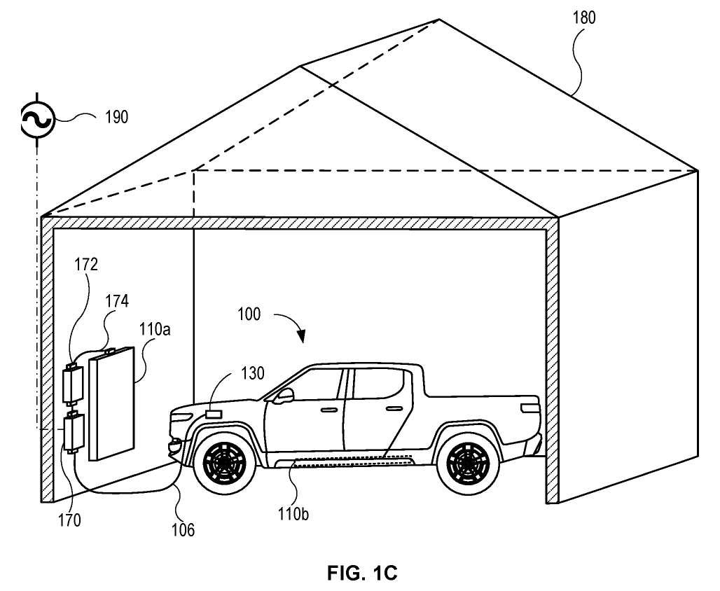

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a cabin 104 and a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within the cabin 104 of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

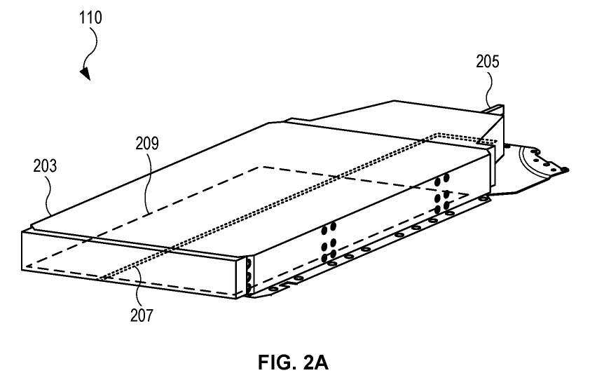

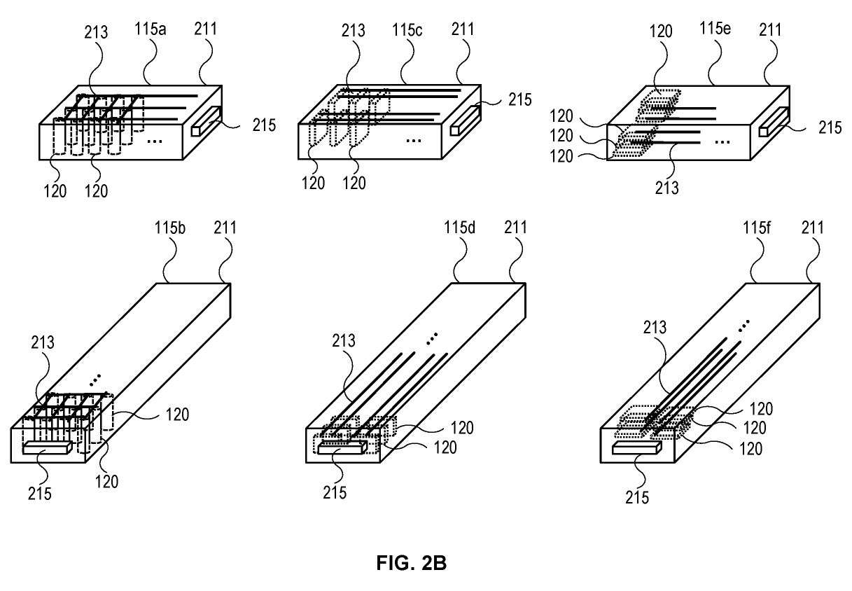

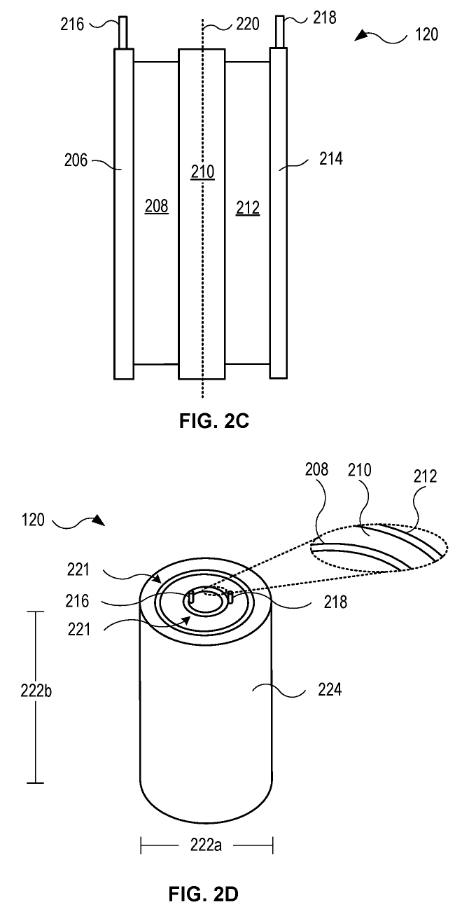

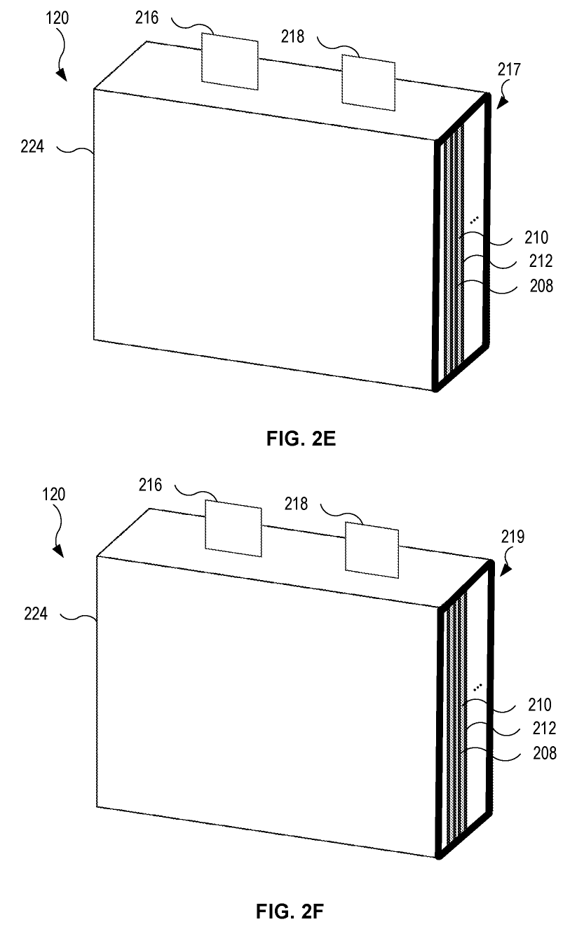

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium-ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium-ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212 and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in one or more implementations, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

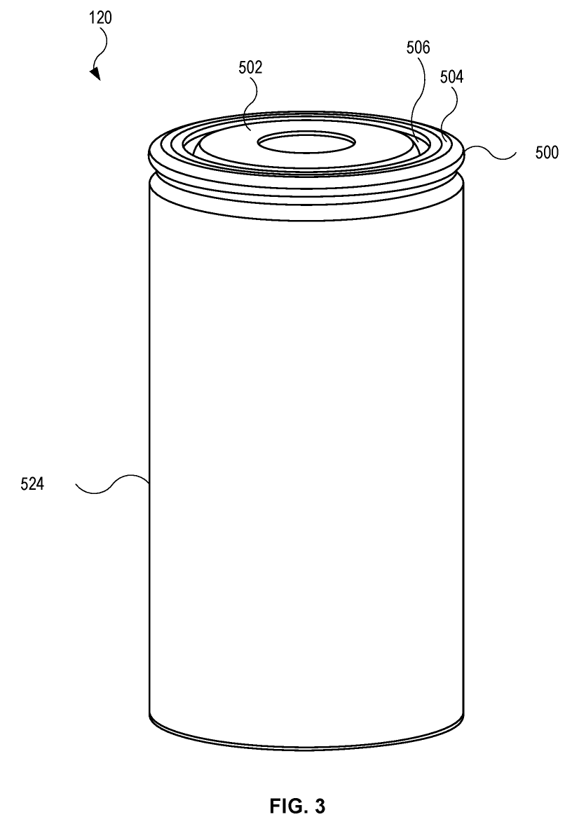

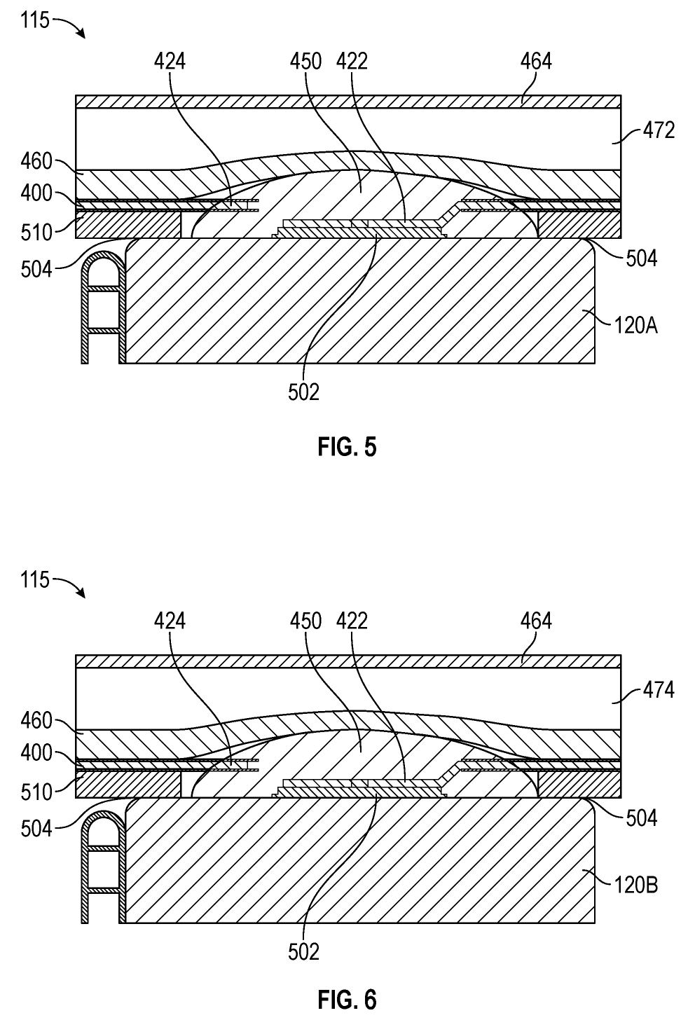

FIG. 3 illustrates a perspective view of an example of a battery cell 120, implemented as a cylindrical cell with a cylindrical cell housing 524, in accordance with one or more implementations. In the example of FIG. 5, the battery cell 120 includes a cap 500 that includes a central portion 502 and a peripheral rim 504. In one or more implementations, the central portion 502 may be implemented as a terminal, such as a positive terminal of the battery cell 120. In one or more implementations, the peripheral rim 504 may be implemented as a terminal, such as a negative terminal of the battery cell 120. In one or more implementations, the battery cell 120 may include a gasket 506 that is disposed at least partially beneath the peripheral rim 504. For example, the gasket 506 may seal an internal cavity of the battery cell 120 (e.g., enclosed by the cylindrical cell housing 524 and the cap 500) from the external environment of the battery cell 120.

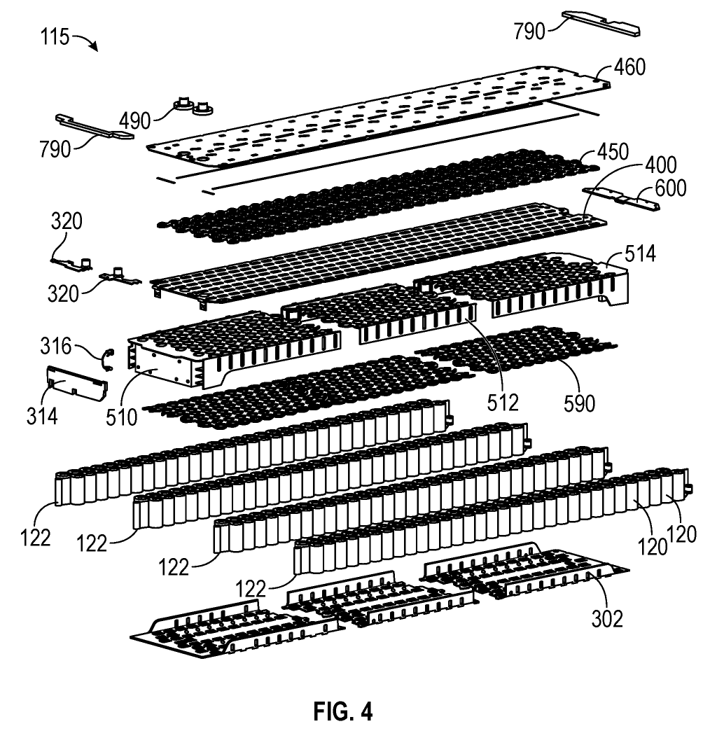

FIG. 4 illustrates a perspective exploded view of a battery module 115. The battery module 115 includes a cover 460, one or more encapsulants 450, a current collector assembly 400, a series busbar 600, one or more frames 510, 512 and/or 514, one or more separation layers 590, one or more sets 122 of battery cells 120, and a base 302.

The cover 460 may be disposed on a top of the battery module 115, and the base 302 may be disposed on a bottom of the battery module 115. The base 302 can be provided as one piece or multiple pieces. The battery cells 120 may be inserted as sets 122 into a crate structure formed by the base 302. One or more of the sets 122 of battery cells 120 can be positioned on opposing sides of a center beam (not shown) and/or within sidewalls of the base 302.

In one or more implementations, each of the frames 510, 512 and/or 514 may take the form of a monolithic unitary body (e.g., a molded body formed from plastic and/or other materials) and may include a top portion and/or sidewalls. Each of the frames 510, 512 and/or 514 can extend across at least a portion of each of the sets 122 of the battery cells 120. The frames 510, 512 and/or 514 can be joined together when secured to the battery cells 120. Where multiple frames 510, 512 and/or 514 are provided, 2 of the frames can form end portions of a joined structure, and one or more additional frames can form a midportion of the joined structure. As such, any configuration, number, and/or length of sets 122 of battery cells 120 can be engaged by a selection of a corresponding set of frames. Each set 122 can secure its battery cells 120 together along a length thereof. Furthermore, the multiple frames 510, 512 and/or 514 can be secured to one or more of the sets 122 to be secured relative to each other along the lengths of the sets 122 of the battery cells 120.

As shown in FIG. 4, a CCA 400 is provided. As discussed in further detail hereinafter, when the battery module 115 is assembled, the CCA 400 may take the form of an apparatus that connects the respective terminals of the battery cells 120 of the battery module 115 to busbar(s) 320. Several busbars may be integrated. For example, a busbar 320 (e.g., a positive busbar) may electrically couple to respective first terminals (e.g., the positive terminals) of the battery cells of the battery module 115, and a busbar 320 (e.g., a negative busbar) may electrically couple to respective second terminals (e.g., the negative terminals) of the battery cells of the battery module 115. As further shown in FIG. 4, a series busbar 600 may also be provided (e.g., on an opposing end of the frames 510, 512 and/or 514 from the end of the respective cell carriers at which the busbar(s) 320 are mounted).

As further shown in FIG. 4, one or more encapsulants 450 can be provided with each between the cover 460 a corresponding one of the battery cells 120. The encapsulants 450 can surround a region at which the CCA 400 connects to the terminals of the corresponding battery cells 120. The encapsulants 450 can further extend to cover and/or contact portions of the frames 510, 512, and/or 514.

The series busbar 600 can be provided to connect sets 122 of the battery cells 120 to each other. For example, the series busbar 600 can be provided to connect first sets 122 of the battery cells 120 on a first side of the center beam 306 to second sets 122 of battery cells 120 on a second side of the center beam 306. The series busbar 600 can be provided on top of one or more of the frames 510, 512, and/or 514. In one or more implementations, the series busbar 600 is provided in a same plane that is occupied by the current collector assembly 400, and/or the encapsulants 450.

In one or more implementations, a balancing voltage and temperature (BVT) module 314 communicatively couples to a thermistor assembly 316. The BVT module 314 may take the form a modular assembly of various electrical components to monitor or control components of the battery module 115. For example, the BVT module 314 may include a circuit board that is attached to a housing of the BVT module 314. The BVT module 314 may include various connectors to couple with, for example, a thermistor, a voltage sensor, and/or a communication device, as non-limiting examples. The thermistor may measure a temperature of the battery module 115 and/or a battery cell 120 thereof. The voltage sensor or balancer may sense or control voltage that flows through the battery module 115 and/or a battery cell 120 thereof. The communication device may receive, transmit, or analyze data associated with the battery module 115 and/or a battery cell 120 thereof.

Referring now to FIGS. 5 and 6, different portions of a battery assembly can include corresponding portion of a compressible layer with variable properties. The different portions of the compressible layer can correspond to different zones of a cabin above the respective portions. The different properties can be selected to provide protection that is appropriate for the corresponding zone.

FIGS. 5 and 6 each illustrate a sectional side view of a respective portion of a battery module. As shown in FIGS. 5 and 6, the cover 460 can extend across an encapsulant 450 that surrounds a top portion of a battery cell 120. The frame 510 can rest on the peripheral rim 504 of the battery cell 120 while leaving the central portion 502 exposed. The CCA 400 (e.g., with the first interconnect portion 422 and the second interconnect portion 424) can extend beyond the frame 510 and to the battery cell 120. The encapsulant 450 can encompass a contact region between a first interconnect portion 422 and the central portion 502 (e.g., terminal) of the battery cell 120. The encapsulant 450 can encompass a contact region between a second interconnect portion 424 and the peripheral rim 504 (e.g., terminal) of the battery cell 120. The encapsulant 450 can extend to the frame 510. The cover 460 can have a shape that accommodates the encapsulants 450. For example, the cover 460 can have a concave shape facing the battery cell 120 (e.g., and/or the encapsulant 450). By further example, the cover 460 can have a convex shape facing away from the battery cell 120. The cover 460 can rest on and/or engage the CCA 400 and/or the frame 510. The cover 460 can be substantially rigid. The cover 460 can be of a material such as a metal (e.g., steel).

In one or more implementations, the cover 460 is integrally (e.g., monolithically) formed with one or more frames (e.g., frames 510, 512, and/or 514). For example, the cover and/or the frame(s) can be extruded about the CCA 400 on opposing sides thereof. The CCA 400 can provide electrical conduction within such an integrated structure.

The cover 460 can receive forces and/or other loads from above, such as from an upper layer 464 and/or through a compressible layer 462. Forces that are applied to the cover 460 can be directed around and away from the encapsulant 450, the first interconnect portion 422, the second interconnect portion 424, and/or the central portion 502 of the battery cell 120. Instead, the forces can be directed to portions of the peripheral rim 504 of the battery cell 120 (e.g., via the CCA 400 and/or the frame 510. As such, the connection between the first interconnect portion 422 and the central portion 502 (e.g., terminal) of the battery cell 120 and between the second interconnect portion 424 and the peripheral rim 504 (e.g., terminal) of the battery cell 120 can be protected despite the forces applied to the cover 460. In one or more implementations, the encapsulant 450 has a modulus of elasticity that is lower than a modulus of elasticity of the cover 460 and a modulus of elasticity of the frame 510. Where forces are transmitted to the encapsulant 450, such forces can be dampened before reaching the connection between the first interconnect portion 422 and the central portion 502 (e.g., terminal) of the battery cell 120 and between the second interconnect portion 424 and the peripheral rim 504 (e.g., terminal) of the battery cell 120.

In one or more implementations, the compressible layer 462 includes a compressible material, such as a foam (e.g., expanded polypropylene) and/or an elastic. Forces applied to the upper layer 464 can be dampened by the compressible layer 462. Such dampening can reduce the magnitude of such forces from a force incident upon the upper layer 464 to a reduced force applied to the cover and/or transmitted thereby to other components. In one or more implementations the compressible layer 462 provides different regions such that the responsiveness of the compressible layer 462 is different among the different regions thereof. For example, as shown in FIG. 5, the compressible layer 462 can include a first region 472 at a first region thereof. By further example, as shown in FIG. 6, the compressible layer 462 can include a second region 474 at a second region thereof. The first region 472 and the second region 474 can each be aligned with a respective region of a cabin on an opposing side of the upper layer 464. For example, as described further herein, different regions of the compressible layer 462 can be aligned with (e.g., below or underlying) different zones of the cabin, including different footwell zones, occupied zones, and/or seating zones.

In one or more implementations, the different regions of the compressible layer 462 can provide properties that are different from each other. In one or more implementations, two or more of the different regions of the compressible layer 462 (e.g., the first region 472, the second region 474, and/or one or more other regions of the compressible layer 462) have different densities. In one or more implementations, two or more of the different regions of the compressible layer 462 (e.g., the first region 472, the second region 474, and/or one or more other regions of the compressible layer 462) have different thicknesses.

In one or more implementations, the different regions of the compressible layer 462 can provide properties that are the same as each other. In one or more implementations, two or more of the different regions of the compressible layer 462 (e.g., the first region 472, the second region 474, and/or one or more other regions of the compressible layer 462) are of the same material. In one or more implementations, two or more of the different regions of the compressible layer 462 (e.g., the first region 472, the second region 474, and/or one or more other regions of the compressible layer 462) have the same thickness (e.g., with respect to a maximum and/or minimum thickness between the upper layer 464 and the cover 460. In one or more implementations, two or more of the different regions of the compressible layer 462 (e.g., the first region 472, the second region 474, and/or one or more other regions of the compressible layer 462) are monolithically formed as a continuous piece with contiguous regions.

In one or more implementations, certain regions can omit portions of the compressible layer 462. For example, one or more seats, consoles, and/or other components within a cabin can include support structures that extend through gaps in the compressible layer. As such, the compressible layer 462 may be omitted in such regions. By further example, some regions between the upper layer 464 and the cover 460 can be occupied by a potting material.

It will be understood that each of the regions of the compressible layer 462 can correspond to different zones defined by a cabin of a vehicle. The properties of each region of the compressible layer 462 can be selected based on the zone of the cabin to which the region corresponds.

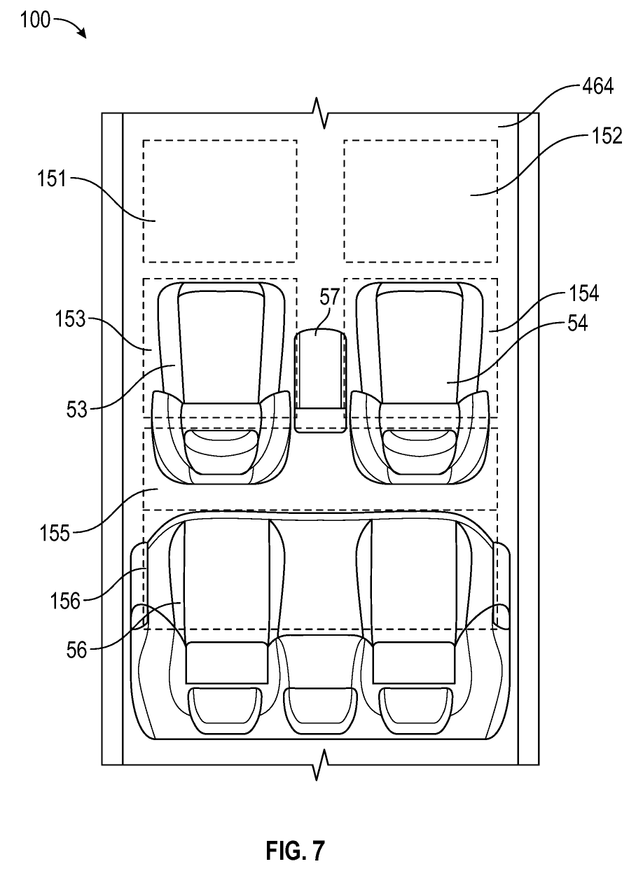

Referring now to FIG. 7, a cabin of the vehicle can be provided with different zones for which regions of a battery subassembly can vary to accommodate the features of each zone. In one or more implementations, the different zones of the vehicle can correspond to the structures provided within a cabin of the vehicle 100 and/or activities that may occur within such zones. As shown in FIG. 7, a cabin 104 of a vehicle 100 can define a first footwell zone 151 adjacent to (e.g., in front of) a first seating zone 153, which can include and/or correspond to a first seat 53 within the cabin 104. As further shown in FIG. 7, the cabin 104 of the vehicle 100 can define a second footwell zone 152 adjacent to (e.g., in front of) a second seating zone 154, which can include and/or correspond to a second seat 54 within the cabin 104. As further shown in FIG. 7, the cabin 104 of the vehicle 100 can define a third footwell zone 155 adjacent to (e.g., in front of) a third seating zone 156, which can include and/or correspond to a third seat 56 within the cabin 104. The third footwell zone 155 can be between the third seating zone 156 and either or both of the first footwell zone 151 and the second footwell zone 152.

The first seat 53, the second seat, 54, and the third seat 56 can provide structures that substantially cover the first seating zone 153, the second seating zone 154, and the third seating zone 156, respectively. It should be recognized that there is a reduced risk of a falling object impacting such zones with substantial force. Accordingly, such zones can be provided with respective regions of a compressible layer thereat with one or more properties that are different than the properties of other regions of the compressible layer. For example, regions of the compressible layer at the first seating zone 153, the second seating zone 154, and/or the third seating zone 156 can have a different (e.g., lower) density than is provided at one or more other regions of the compressible layer (e.g., regions corresponding to the first footwell zone 151, the second footwell zone 152, and/or the third footwell zone 155).

In one or more implementations, the second seat 54 and the third seat 56 are passenger seats that may not be occupied by passengers while the vehicle 100 is in motion. Rather, other objects may occupy the second seat 54 and the third seat 56. When the vehicle 100 changes its speed and/or direction, such objects may be at risk of falling forward onto a corresponding zone, such as the second footwell zone 152 and/or the third footwell zone 155. Accordingly, it should be recognized that there is a risk that such objects may impact the surface of the second footwell zone 152 and/or the third footwell zone 155. Accordingly, such zones can be provided with respective regions of the compressible layer thereat with one or more properties that are different than the properties of other regions of the compressible layer. For example, regions of the compressible layer at the second footwell zone 152 and/or the third footwell zone 155 can have a different (e.g., higher) density than is provided at one or more other regions of the compressible layer (e.g., regions corresponding to the first seating zone 153, the second seating zone 154, and/or the third seating zone 156). Such properties can provide additional robustness and dampening against forces applied during impact of an object at the upper layer 464.

In one or more implementations, the first seat 53 is a driver’s seat that is to be occupied by a driver of the vehicle 100 while the vehicle 100 is in motion. Accordingly, it should be recognized that there is a reduced risk of objects occupying the first seat 53 would fall from the first seat 53 to impact the surface of the first footwell zone 151. Accordingly, the first footwell zone 151 can be provided with respective regions of the compressible layer thereat with one or more properties that are different than the properties of other regions of the compressible layer. For example, regions of the compressible layer at the first footwell zone 151 can have a different (e.g., higher) density than is provided at one or more other regions of the compressible layer (e.g., regions corresponding to the first seating zone 153, the second seating zone 154, and/or the third seating zone 156). Such properties can provide some additional robustness and dampening against forces applied during impact of an object at the upper layer 464. By further example, regions of the compressible layer at the first footwell zone 151 can have a different (e.g., lower) density than is provided at one or more other regions (e.g., regions of the compressible layer corresponding to the second footwell zone 152 and/or the third footwell zone 155). Accordingly, the regions of the compressible layer at the first footwell zone 151 can have a density that is higher than a density of the regions of the compressible layer corresponding to the first seating zone 153, the second seating zone 154, and/or the third seating zone 156, and the regions of the compressible layer at the first footwell zone 151 can also have a density that is lower than a density of the regions of the compressible layer corresponding to the second footwell zone 152 and/or the third footwell zone 155.

It should be recognized that any number of different zones can be provided with corresponding regions of a compressible layer corresponding thereto. It should be recognized that any number of seating zones and/or footwell zones can be provided. For example, while two rows of seating zones are illustrated in FIG. 7, it should be recognized that any number (e.g., three or more) of rows can be provided, with a corresponding one or more footwell zones adjacent (e.g., in front of) thereto.

Accordingly, the compressible layer of a battery subassembly can be provided with different regions having different properties to provide the desired features and particular zones of a cabin. Such an arrangement provides both resilience and compressibility where desired to protect components of the battery subassembly and to optimize assembly and manufacturing processes.

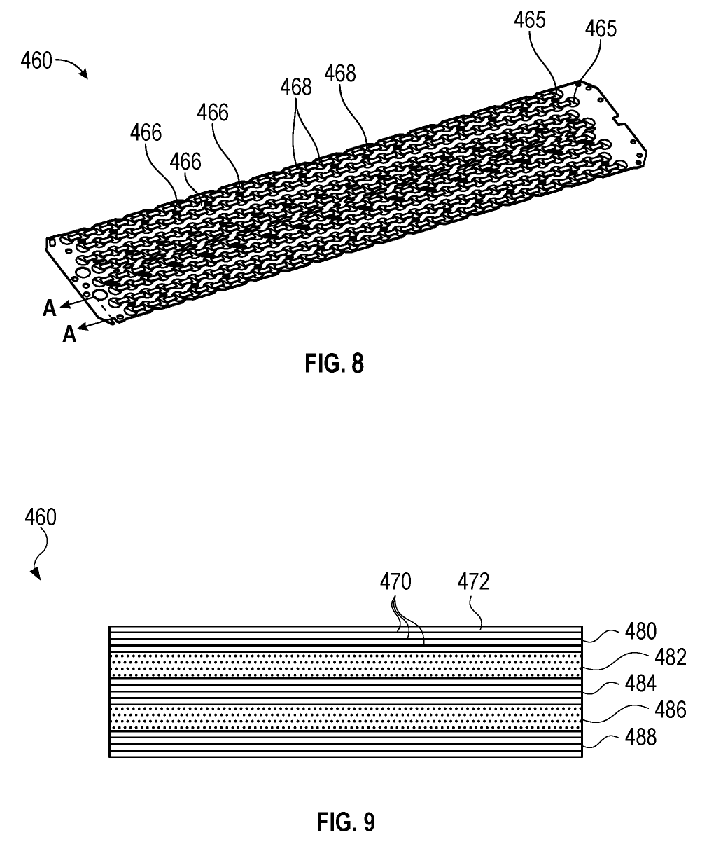

Referring now to FIGS. 8 and 9, a cover can provide additional protection to batteries of a battery subassembly. FIGS. 8 illustrates an example of a cover 460. In one or more embodiments, the cover 460 can be a composite protective cover with compression molded structural domes 466 and channels 468 that help dissipate loads in the Z direction (e.g., orthogonal to the surface of the cover 460) and prevent deformation of underlying battery cells, thereby preventing thermal runaway. The compression molded structural domes 466 and channels 468 can house the encapsulant adhesive to protect the welds between the battery cells and the current collector assembly.

In one or more implementations, and as shown in FIG. 8, the cover 460 can include one or more domes 466, each forming a concave shape on a first side of the cover 460 and a convex shape on a second side of the cover 460. As further shown in FIG. 8, the cover 460 can include one or more channels 468. The channels 468 can extend between and/or connect to two or more of the domes 466 formed in a given one of multiple rows 465, such that the separate spaces that are partially encompassed by the connected domes are connected to form a continuous space. The channels 468 can extend in parallel between and/or to opposing ends of the cover 460.

Where the shape and/or size of individual domes 466 vary, one or more domes 466 having a common first shape and/or size can be arranged in a common one of the rows 465, and one or more domes 466 having a common second shape and/or size, different from the first shape and/or size, can be arranged in a different one of the rows 465. The cover 460 can optionally omit one or more channels 468 in one or more of the rows 465.

The cover 460 can include, for example at a bottom side thereof, an adhesive (not shown) for securing to an underlying structure of the assembly. For example, the cover 460 can be joined to the layers underneath using a pressure sensitive adhesive (PSA) tape and/or another adhesive and/or securement mechanism. By further example, the adhesive can be provided via roll dispensing onto the cover 460. The adhesive can be provided between, alongside, within, and/or across one or more domes 466 and/or one or more channels 468. In some embodiments, the adhesive can be provided at multiple locations and/or extending in different directions to provide securement against forces that may be provided in a variety of directions. In some embodiments, the cover 460 can be joined to the layers underneath using adhesive, heat staking, push clips, welding, riveting, and/or combinations thereof.

In one or more implementations, as shown in FIG. 9, a cover 460 can include multiple layers to provide structural support in a thin form factor. As shown in FIG. 9, the cover 460 can include multiple (e.g., five) layers 480, 482, 484, 486, and 488. It could be recognized that the cover 460 can include any number of layers. Each of the layers 480, 482, 484, 486, and 488 includes fibers 470 within a polymer matrix 478. The fibers 470 of a first layer 480 extend in a first direction, and the fibers of a second layer 482 extend in a second direction different from the first direction. In one or more implementations, the first direction is transverse (e.g. orthogonal) to the second direction.

Where additional layers are provided, the direction of fibers can alternate between two different directions. For example, the first layer 480, the third layer 484, and the fifth layer 488 can include fibers 470 that extend in the first direction (e.g., illustrated in FIG. 9 as across a plane of the page). By further example, the second layer 482 and the fourth layer 486 can include fibers 470 that extend in the second direction (e.g., illustrated in FIG. 9 as into and/or out of the plane of the page). By alternating the direction in each of adjacent layers, the resulting cover 460 provides rigidity against forces incident on a top surface thereof. In some embodiments, the outermost layers provide fibers 470 that extend in a long axis of the cover 460. The fibers 470 can extend continuously along the long axis to ends of the cover 460 without interruptions or discontinuities. In some embodiments, the cover 460 includes a greater number of layers having fibers 470 that extend in a long axis of the cover 460 that a number of layers having fibers 470 that extend in a different direction (e.g., of a short axis of the cover 460).

In one or more implementations, the fibers 470 include glass. In one or more implementations, the fibers 470 include glass with mica particles. In one or more implementations, the polymer matrix 478 includes polypropylene, polyethylene terephthalate and/or another thermoplastic polymer, such as a polymer with high surface energy. In one or more implementations a bottommost layer and/or a topmost layer of the composite cover 460 can be made from a first polymer (e.g., polyethylene terephthalate), such as a polymer with high surface energy to provide high adhesion surface for interfacing components. In one or more implementations, one or more layers between the bottommost layer and the topmost layer of the composite cover 460 can be made from a second polymer (e.g., polypropylene) different from the first polymer. The weight content (e.g., proportion by weight) of the fibers 470 in each layer can be between 30-80%. The weight content of the fibers 470 in each of different adjacent layers can be different from each other. The thickness of each of the layers 480, 482, 484,486, and 488 can be between 0.15-0.50 mm. The thickness of different adjacent layers can be different from each other. The total thickness of all layers forming the cover 460 can be desirably thin (e.g., approximately 1.0 mm).

Accordingly, the cover 460 can be formed with materials and an arrangement that provides structural support, electrical insulation, thermal resilience, and low humidity absorption rate. The cover 460 can be provided with a desired low thickness in a shape that facilitates directing forces to targeted regions of battery cells, as described herein.

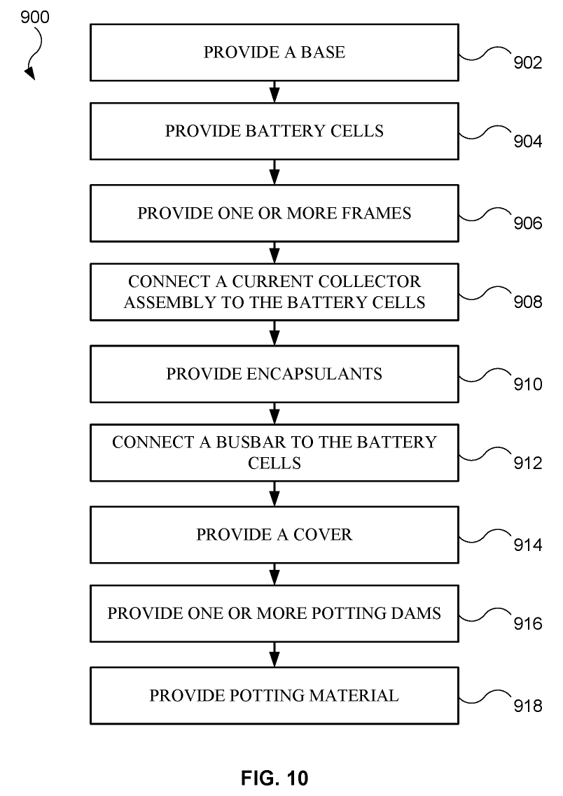

FIG. 10 illustrates a flow diagram showing an example of a process 900 that may be performed for forming a battery module in accordance with one or more implementations of the present disclosure. For explanatory purposes, the process 900 is primarily described herein with reference to components illustrated in FIGS. 4–9. However, the process 900 is not limited to the components illustrated in FIGS. 4–9, and one or more blocks (or operations) of the process 900 may be performed with one or more other components of other suitable apparatuses, devices, or systems. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

At block 902, a base is provided. The base can be configured and arranged to support one or more battery cells, including one or more such a battery cells.

At block 904, one or more battery cells and/or sets of battery cells is provided. For example, the battery cells and/or sets of battery cells can be provided to the base. Sets of the battery cells can be separated, for example by a center beam.

At block 906, one or more frames is provided. For example, the one or more frames can be provided extending over one or more battery cells and/or such as battery cells.

At block 908, a current collector assembly is connected to each of one or more battery cells. For example, the current collector assembly can be provided on top of the one or more frames, and portions of the current collector assembly can extend through the frame to connect to terminals of the battery cells.

At block 910, one or more encapsulants can be provided. For example, each of the encapsulants can cover a portion of the frame, a portion of a battery cell (e.g., terminals), and a portion of the current collector assembly (e.g., interconnect portions).

At block 912, a busbar is connected to one or more of the battery cells and/or sets of the battery cells. For example, the busbar can be provided on top of a portion of one or more frames. By further example, the busbar can connect a first set of battery cells on a first side of a center beam to a second side of battery cells on a second side of the center beam.

At block 914, a cover is provided. For example, the cover can be provided on top of at least a portion of the one or more frames, the current collector assembly, and/or the encapsulants.

At block 916, one or more potting dams is provided. For example, a potting dam can be provided at each end of a portion of the battery module.

At block 918, a potting material is provided. For example, the potting material can be provided to infiltrate into and/or between one or more components of the battery module. The one or more potting dams can retain the potting material within a region of the battery module.

Aspects of the subject technology can help extend the life of a battery in a vehicle. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being "connected" or "coupled" to another element, it is to be understood that the elements can be directly connected to the other element, or have intervening elements present between the elements. In contrast, when an element is referred to as being "directly connected" or "directly coupled" to another element, it should be understood that no intervening elements are present in the "direct" connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An electric vehicle comprising:
a cabin defining:
a first footwell zone; and
a second footwell zone; and
battery subassembly including:
a cover for extending across multiple battery cells; and
a compressible layer abutting the cover, the compressible layer including a first region and a second region, wherein the first region of the compressible layer is configured to be aligned with the first footwell zone, the first region having a first density, wherein the second region of the compressible layer is configured to be aligned with the second footwell zone, the second region having a second density different from the first density.

2. The electric vehicle of claim 1, wherein the cabin further includes a third footwell zone, wherein the compressible layer further includes a third region that is configured to be aligned with the third footwell zone, the third region having the second density.

3. The electric vehicle of claim 1, wherein the second density is higher than the first density.

4. The electric vehicle of claim 1, wherein the cabin further includes a seat, wherein the compressible layer further includes a fourth region that is configured to be aligned with the seat, the fourth region having a third density different from the first density and the second density.

5. The electric vehicle of claim 4, wherein the third density is lower than the first density and the second density.

6. The electric vehicle of claim 1, wherein the battery subassembly further includes an upper layer on a side of the compressible layer that is opposite the cover.

7. A battery subassembly comprising:
a frame for abutting a peripheral rim of a battery cell; and
a cover configured to direct forces applied thereto onto the peripheral rim of the battery cell, wherein the cover includes a first layer and a second layer, wherein each of the first layer and the second layer includes fibers within a polymer matrix, wherein the fibers of the first layer and extend in a first direction and the fibers of the second layer extend in a second direction different from the first direction.

8. The battery subassembly of claim 7, wherein the fibers include glass fibers.

9. The battery subassembly of claim 7, wherein the polymer matrix includes polypropylene.

10. The battery subassembly of claim 7, wherein the cover includes a third layer, wherein the second layer is between the first layer and the third layer, wherein fibers of the third layer extend in the first direction.

11. The battery subassembly of claim 7, wherein the second direction is orthogonal to the first direction.

12. The battery subassembly of claim 7, wherein the fibers of the first layer extend to ends of the cover.

13. The battery subassembly of claim 7, further comprising a current collector assembly between the frame and the cover, wherein the cover is configured to direct forces applied thereto away from an encapsulant between the cover and a central portion of the battery cell and onto the peripheral rim of the battery cell.

14. The battery subassembly of claim 7, wherein the cover forms an inner surface defining a concave shape for facing a central portion of the battery cell.

15. The battery subassembly of claim 7, further comprising:
a base; and
potting material between the cover and the base.

16. The battery subassembly of claim 7, further comprising a layer of foam on a side of the cover that is opposite the frame.

17. A method of assembling a battery subassembly, the method comprising:
providing battery cells, wherein each of the battery cells defines a central portion including a first terminal and a peripheral rim including a second terminal;
providing one or more frames (510, 512, 514) abutting the peripheral rim of each of the battery cells;
providing a cover over the one or more frames; and
providing a compressible layer over the cover, wherein the compressible layer includes multiple regions having different densities with respect to each other.

18. The method of claim 17, wherein providing the compressible layer includes aligning each of the multiple regions of the compressible layer with respective footwell zones of a cabin.

19. The method of claim 17, further comprising forming the cover by joining a first layer and a second layer, wherein each of the first layer and the second layer includes fibers within a polymer matrix, wherein the fibers of the first layer and extend in a first direction and the fibers of the second layer extend in a second direction different from the first direction.

20. The method of claim 17, further comprising:
providing an encapsulant over the central portion of each of the battery cells;
connecting a current collector assembly to the first terminal and the second terminal of each of battery cells;
providing a base to support the battery cells; and
providing potting material between the cover and the base.
